(19) United States
(12) Patent Application Publication
(10) Pub. No.: US 2024/0385908 A1
(43) Pub. Date: Nov. 21, 2024

(54) AUTOMATED LOCALIZATION OF MICROSERVICES

(71) Applicant: Dell Products L.P., Round Rock, TX (US)

(72) Inventors: Lior Gdaliahu, Modi'in (IL); Yonit Lopatinski, Shomria (IL); Roman Bober, HaDarom (IL); Eli Rosenes, Bet Shemesh (IL); Kirk Alan Hutchinson, Londonderry, NH (US)

(21) Appl. No.: 18/199,148

(22) Filed: May 18, 2023

(51) Int. Cl. G06F 9/54; G06F 40/103; G06F 40/58

(52) U.S. Cl. CPC G06F 9/541; G06F 40/103; G06F 40/58

(57) ABSTRACT

Techniques are provided for automated localization of microservices. One method comprises obtaining, by a given microservice of an application, a message to be provided to a client device using an application programming interface (API) of the given microservice, wherein the message comprises a text portion having an identifier, wherein the text portion is in a first language; obtaining, by the given microservice, using the identifier, a translation of the text portion, maintained by the given microservice, in a second language associated with the client device; and presenting, by the given microservice, the message, with the translation of the text portion, to the client device using the API of the given microservice. Continuous integration aggregation techniques may be used to: (i) detect changes to localized files of the application; (ii) transform changed localized files to a file format; and (iii) store the changed localized files in a shared storage for translation.

### FIELD

The field relates generally to information processing systems, and more particularly to microservices associated with such information processing systems.

### BACKGROUND

A software application is often comprised of multiple microservices. Globalization is the process of adapting software products (e.g., a software application) to an international audience. A globalized application can be configured to interact with users from different locations.

### SUMMARY

In one embodiment, a method comprises obtaining, by a given microservice of a plurality of microservices of an application, a message to be provided to a client device using an application programming interface (API) of the given microservice, wherein the message comprises at least one text portion having at least one respective identifier, wherein the at least one text portion is in a first language; obtaining, by the given microservice, using the at least one respective identifier, a translation of the at least one text portion, maintained by the given microservice, in a second language associated with the client device; and presenting, by the given microservice, the message, with the translation of the at least one text portion, to the client device using the API of the given microservice.

In some embodiments, the application is written in the first language using a designated programming language, and wherein the application is developed using continuous integration aggregation to (i) detect changes to one or more localized files of the application; (ii) transform the one or more changed localized files from the designated programming language of the application to a file format; and (iii) store the one or more changed localized files in the file format in a shared storage for translation by one or more translation organizations. The one or more translated localized files may be stored in the shared storage as language packages. During an installation of the application, the language packages associated with the given microservice can be provided to the given microservice for storage in a data store associated with the given microservice. The application may be updated with one or more updates to the one or more changed localized files during an execution of the application.

In one or more embodiments, the translation of the at least one text portion employs a formatting designated for the client device. The application may execute in one or more of a public cloud, a private cloud, and at a location of an organization. A translation of a given text portion of the application may be reused in some embodiments, across the plurality of microservices.

Other illustrative embodiments include, without limitation, apparatus, systems, methods and computer program products comprising processor-readable storage media.

### BRIEF DESCRIPTION OF THE DRAWINGS

FIGS. 1A and 1B illustrate an information processing system configured for automated localization of microservices in accordance with an illustrative embodiment;

FIG. 2 illustrates a development of a plurality of microservices of a globalized application in accordance with an illustrative embodiment;

FIG. 3 illustrates an installation of a plurality of microservices of a globalized application in accordance with an illustrative embodiment;

FIG. 4 illustrates an execution of a plurality of microservices of a globalized application in accordance with an illustrative embodiment;

FIG. 5 is a flow chart illustrating an exemplary implementation of a process for automated localization of microservices in accordance with illustrative embodiments;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for automated localization of microservices.

Globalization is the process of adapting and selling software products (e.g., an application) to an international audience. Globalization generally comprises both internationalization and localization. A globalized application (or other software) is an application developed for a global audience that can be adapted to different locations (e.g., countries and/or regions that utilize the same language and/or other regional conventions). Internationalization is generally directed to the design of software so that it can be adapted to local languages and/or other local conventions. Localization is generally directed to the adaptation of software content to particular locations, for example, by translating text and adding locale-specific components. Translation is the process of converting text from one language (e.g., a source language) to at least one other language (e.g., one or more target languages).

An application is typically comprised of multiple microservices, where each microservice is associated with a given domain of the application (e.g., an event service domain, an alert service domain and/or a rules service domain). A globalized application can be configured to interact with users from different locations, for example, in culturally appropriate ways (e.g., in a local language and conforming to local currencies, as well as local date and time formats).

Microservice architectures distribute domains across a computing cluster. In such microservice architectures, the text of each microservice (e.g., the text that is presented to a user) is typically separately maintained from other microservices. In a globalized application, a user in one region sees error messages, outputs of the application and interface elements (e.g., elements of an API) in a given requested (or default) language of the regional user.

In one or more embodiments, automated microservice localization techniques are provided that use CI/CD (continuous integration/continuous deployment) techniques to automatically manage domain text and a globalization process. Among other benefits, the disclosed techniques for automated localization of microservices simplify the development of such globalized applications and improve the performance of dynamic localized translation at runtime, for example, using CI/CD automation processes during development and a disclosed microservice-centered runtime localization process. Existing globalization techniques typically employ (i) a single service to manage the runtime handling of the localization for a given software product using the available translations, and (ii) a single passthrough service (e.g., having one associated API with the localization information) where translations are provided during egress to the user. Thus, the internationalization service must scale to support all related microservices and requires per-domain internationalization business logic to be implemented within the internationalization service.

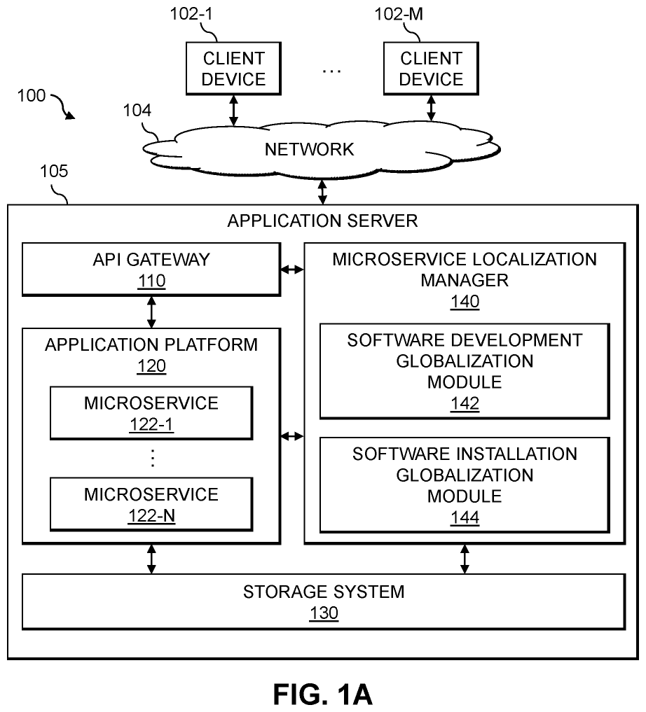

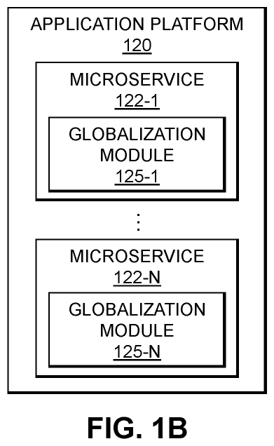

FIG. 1A shows an information processing system 100 configured for securely executing microservices in an illustrative embodiment. The information processing system 100 comprises client devices 102-1, . . . 102-M (collectively “client devices 102”), a network 104, and an application server 105.

The client devices 102 can comprise, for example, Internet of Things (IoT) devices, desktop, laptop or tablet computers, mobile telephones, or other types of processing devices capable of communicating with the application server 105 over the network 104. Such devices are examples of what are more generally referred to herein as “processing devices.” Some of these processing devices are also generally referred to herein as “computers.” It is also to be appreciated that the term “client device” is intended to be broadly construed so as to also encompass, for example, a calling application and/or a calling service that is connected on a network (e.g., network 104). Also, it is to be understood that a given one of the client devices 102 can encompass a computer, where a user accesses or interacts with a calling application even if the calling application is not on the computer (e.g., the calling application could be on one or more computing platforms, including the same one that a requested microservice is executed on).

The client devices 102 may comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the terms “client” and “user” as described herein are intended to be broadly construed so as to encompass numerous arrangements of human, hardware, software or firmware entities, as well as combinations of such entities.

The client devices 102 can access the application server 105 over the network 104. The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

The application server 105 in the FIG. 1A embodiment is assumed to be implemented using at least one processing device. Each such processing device generally comprises at least one processor and an associated memory, and implements one or more functional modules for controlling certain features of the application server 105.

More particularly, the application server 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the application server 105 to communicate over the network 104 with the client devices 102, and illustratively comprises one or more conventional transceivers.

In the FIG. 1A example, the application server 105 further comprises an API gateway 110, an application platform 120, a storage system 130, and a microservice localization manager 140. The application server 105 is configured to perform data processing, data storage, and data management functions to support one or more cloud-based or web-based applications or services and/or other types of applications that are implemented by the application platform 120. It is to be appreciated that at least a portion of the available services and functionalities provided by the application server 105 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

The application platform 120 of the application server 105 is assumed to implement at least a portion of a microservice architecture which includes a plurality of microservices 122-1, . . . 122-N (collectively, microservices 122) that are combined to provide a structured application. For example, the microservice architecture may implement an application as a collection of loosely-coupled services, wherein the services expose fine-grained APIs and lightweight protocols. Each microservice 122 can include a self-contained software module with associated functionality and interfaces. In some embodiments, the application platform 120 runs in a virtualized environment (e.g., virtual machines) or a containerized environment (e.g., containers) in which the number of instances of a given microservice and the locations (e.g., host and port) of such instances change dynamically.

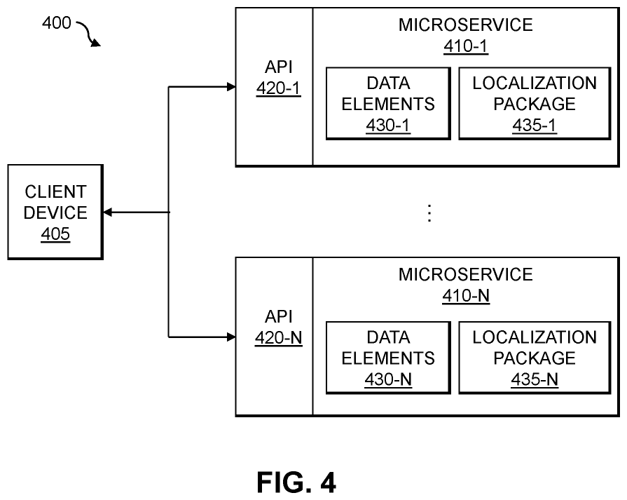

FIG. 1B illustrates the application platform 120 of FIG. 1B in further detail. In the microservices architecture of FIG. 1B, each microservice 122-1 through 122-N (and instances thereof) within application platform 120 comprises a respective globalization module 125-1 through 125-N configured to provide runtime automated microservice localization functionality for a respective microservice 122 of a globalized application, as discussed further below in conjunction with FIG. 4. In some embodiments, the functionality of the globalization modules 125 may be incorporated into the source code of the respective microservice 122.

In the microservices architecture of FIG. 1A, each microservice 122 (and instances thereof) may expose a set of fine-grained endpoints to access resources provided by the microservice. Each endpoint specifies a location from which APIs can access the resources needed to perform functions. Each microservice 122 can maintain its own database in the storage system 130 in order to be decoupled from other microservices. The microservice-based framework enables the individual microservices 122 to be deployed and scaled independently, to be developed and updated in parallel by different teams and in different programming languages, and to have their own continuous delivery and deployment stream. While the application platform 120 is generically depicted in FIG. 1A, the application platform 120 can implement any suitable cloud-based application (e.g., multi-tenant Saas (software-as-a-service) application). For example, the application platform 120 can implement a cloud-based SaaS application that allows customers to monitor, analyze, and troubleshoot their storage systems, or any other type of SaaS application which comprises hundreds or thousands of microservices and associated endpoints.

The storage system 130, in at least some embodiments, can be implemented using any of a variety of different types of storage including network-attached storage (NAS), storage area networks (SANs), direct-attached storage (DAS) and distributed DAS, as well as combinations of these and other storage types, including software-defined storage. For example, the storage system 130 can include a plurality of storage nodes comprising storage appliances with memory controllers, processors, cache memory, and non-volatile storage media to provide persistent storage resources (e.g., file repositories, databases, etc.) for the application platform 120 and/or other components or systems associated with the application server 105.

The API gateway 110 implements methods that are configured to enable client applications to access the services of the application platform 120. In particular, the API gateway 110 provides a single-entry point for client applications to issue API requests for services that are provided by the application platform 120. The API gateway 110 abstracts the client applications from knowing how the application platform 120 is partitioned into microservices, and from having to determine the locations of service instances. The API gateway 110 comprises logic for calling one or more of the microservices 122 in response to a client request. The API gateway 110 communicates with client applications and the microservices 122 using any suitable API framework. For example, in some embodiments, the API gateway 110 and the microservices 122 implement a REST API. In other embodiments, the API gateway 110 and the microservices 122 implement a SOAP API.

In at least some embodiments, a login portal can be associated with the API gateway 110 to allow client applications running on client devices (e.g., client devices 102) to access the individual microservices 122 of the application platform 120. In such an example, the login portal can include a user interface which implements methods that allow a user to connect to the application server 105 (via a client device 102) and log in to the application server 105 and provide credentials for a user authentication/verification process. In some embodiments, the login portal comprises different user interfaces to support connectivity with different types of devices (for example, mobile devices, desktop computers, servers, etc.) and different types of HTML-based browsers.

In some embodiments, the API gateway 110 is implemented using a single gateway service that is configured to interface with many different types of client applications (e.g., web-based applications, mobile applications, etc.). In other embodiments, the API gateway 110 comprises a plurality of gateway services, each configured to interface with a different type of client application. In all instances, the API gateway 110 performs various functions. For example, the API gateway 110 functions as a reverse proxy to redirect or route requests from client applications to target endpoints of the microservices 122. In this instance, the API gateway 110 provides a single endpoint or Uniform Resource Locator (URL) to receive requests from client applications for access to services of the application platform 120, and internally maps client requests to one or more of the microservices 122.

Furthermore, the API gateway 110 can implement aggregation services to aggregate multiple client requests (e.g., HTTP requests) which target multiple microservices 122 into a single request. In this instance, a client application may send a single request to the API gateway 110 to perform a single task, and the API gateway 110 dispatches multiple calls to different backend microservices 122 to execute the task. The API gateway 110 aggregates the results from the multiple microservices and sends the aggregated results to the client application. In this instance, the client application issues a single request and receives a single response from the API gateway 110 despite the single request being parsed and processed by multiple microservices 122. The API gateway 110 can be configured to implement other functions or microservices to implement authentication and authorization, service discovery, response caching, load balancing, etc.

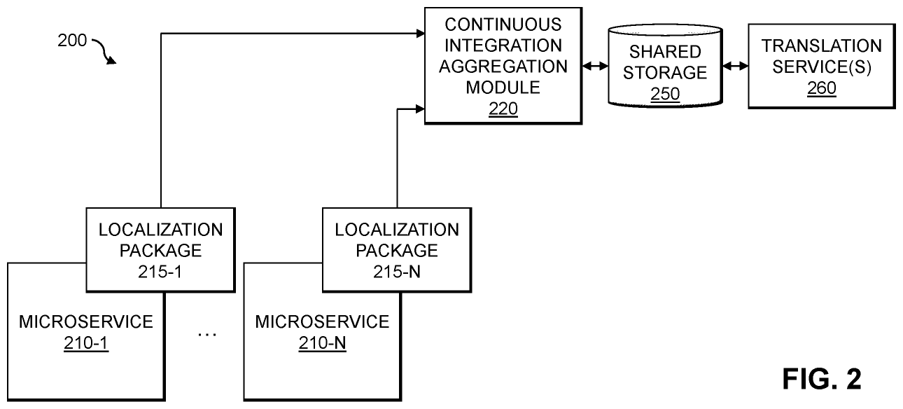

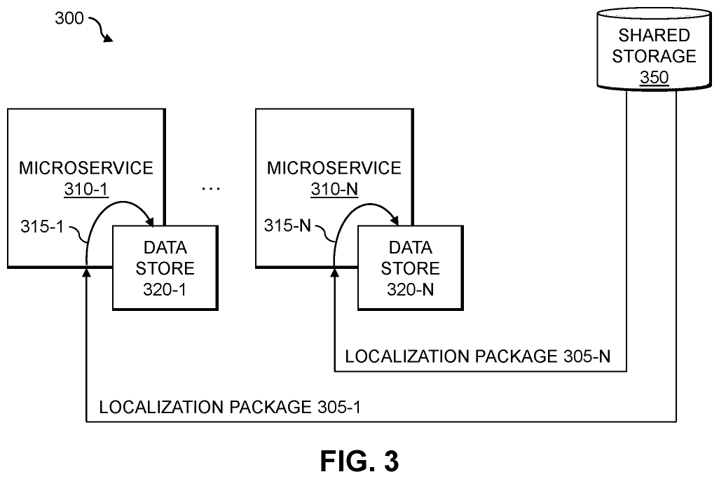

In the example shown in FIG. 1A, the microservice localization manager 140 includes a software development globalization module 142 and a software installation globalization module 144. Generally, the software development globalization module 142 is configured to employ CI/CD techniques in some embodiments to generate the software code and associated files for one or more microservices of a globalized application, as discussed further below in conjunction with FIG. 2. The software installation globalization module 144 is configured to install localization packages in respective microservices, as discussed further below in conjunction with FIG. 3.

It is to be appreciated that this particular arrangement of API gateway 110, the application platform 120, the storage system 130, the microservice localization manager 140, the software development globalization module 142 and the software installation globalization module 144 illustrated in the application server 105 of the FIG. 1A embodiment is presented by way of example only, and alternative arrangements can be used in other embodiments. For example, the functionality associated with the elements 110, 120, 130, 140, 142, and/or 144, or portions thereof, in other embodiments can be combined into a single module, or separated across a larger number of modules. As another example, multiple distinct processors can be used to implement different ones of the elements 110, 120, 130, 140, 142, and/or 144 or portions thereof.

At least portions of elements 110, 120, 130, 140, 142, and/or 144 may be implemented at least in part in the form of software that is stored in memory and executed by a processor.

It is to be understood that the particular set of elements shown in FIG. 1A for application server 105 involving client devices 102 of information processing system 100 is presented by way of illustrative example only, and in other embodiments additional or alternative elements may be used. Thus, another embodiment includes additional or alternative systems, devices and other network entities, as well as different arrangements of modules and other components. As a non-limiting example, in at least one embodiment, the API gateway 110, the application platform 120, the storage system 130, the software development globalization module 142, and/or the software installation globalization module 144 may be implemented on one or more other processing platforms that are accessible to the application server 105 over one or more networks. Such components can each be implemented at least in part within another system element or at least in part utilizing one or more stand-alone components coupled to the network 104.

An exemplary process utilizing elements 142 and 144 of an example application server 105 in information processing system 100 will be described in more detail with reference to, for example, FIGS. 2 through 4, respectively.

FIG. 2 illustrates a software development stage 200 of a plurality of microservices 210-1 through 210-N (collectively, referred to herein as microservices 210) of a globalized application in accordance with an illustrative embodiment. In at least some embodiments, one or more of the following elements may be employed during the software development stage 200: (i) local development environments (e.g., the computers of individual developers); (ii) a CI server (or a development server); and/or (iii) one or more test servers (e.g., for functional user interface testing of the product), as would be apparent to a person of ordinary skill in the art.

In the example of FIG. 2, during the software development stage 200, CI/CD techniques are employed to develop one or more of the microservices 210-1 through 210-N (e.g., to generate the software code and associated files for the one or more of the microservices 210). For example, a localization package 215-1 through 215-N (collectively, referred to herein as localization packages 215) is generated during the software development stage 200 for each respective microservice 210-1 through 210-N.

In some embodiments, a main branch may correspond to software code of at least one microservice 210. A release branch may be created based on the main branch. For example, the release branch may be created based on development release timelines corresponding to the software application. One or more developers (e.g., corresponding to client devices 102) create respective personal branches based on the release branch, and may perform development work using a sandbox environment and a code IDE (integration development environment). Many developers prefer to write software code using such an IDE that allows the software to be developed in any programming language without having to deal with a particular language syntax. Developers may have multiple IDEs available for application development. Developers can commit the changes made in their personal branches to the release branch.

The microservices 210 of the globalized application of FIG. 2 may be written in a source language using a designated programming language. In one or more embodiments, the localization packages 215 comprise text portions of messages, for example, that will be presented by the respective microservice 210 to client devices 102, as discussed further below in conjunction with FIG. 4. The text portions of messages will be written in the source language and translated into localized target languages (for example, with localized formatting) using the disclosed automated microservice localization techniques. Each text portion has a corresponding identifier that can be used by the respective microservice 210 during execution of the application, for example, to translate the source language text portion into a localized target language.

As shown in FIG. 2, the localization packages 215 are applied to a continuous integration aggregation module 220. The continuous integration aggregation module 220 provides functionality for automating the integration of new software code and/or software code changes from multiple software developers or other DevOps professionals into a single software project. In at least some embodiments, the continuous integration aggregation module 220, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration aggregation module 220 may be configured, for example, to perform CI/CD tasks and to provide access to DevOps tools and/or repositories.

In addition, the continuous integration aggregation module 220 detects changes to one or more localized files of the application (e.g., associated with one or more of the localization packages 215 in the source language). The continuous integration aggregation module 220, such as a GitHub CI/CD tool implementation of the continuous integration aggregation module 220, employs pattern matching and/or rules (e.g., using file name extensions and/or sub-directory locations) in some embodiments in response to detecting directory changes associated with the source code of one or more of the microservices 210. For example, each microservice 210 can have a “Locale” directory with sub-directories for each supported target language (with each sub-directory storing an actual language file).

The continuous integration aggregation module 220 may look for new and/or changed directories and process the content of such new or changed directories to transform the one or more changed localized files (e.g., in the source language) from the designated programming language of the application to a file format, such as a JSON (JavaScript Object Notation) file format. The continuous integration aggregation module 220 aggregates the source code changes from the microservices 210 and stores the one or more changed or new localized files in the file format in a shared storage 250. In addition, the continuous integration aggregation module 220 may combine the changed or new localized files into one directory structure in the shared storage 250, and may provide at least some of the changed or new localized files to one or more translation services 260 for translation. Following the translations (e.g., into multiple target languages), the translated files (e.g., translated versions of the localization packages 215) are also stored in the shared storage 250 together with the default localized files. The translated text portions may employ a formatting (e.g., date and time formatting) designated for each target language. In addition, a translation of a given portion of text of the application (or of a microservice 210) may be reused across other microservices 210).

When a globalized application or one or more microservices 210 of the globalized application is updated, the localization package 215 associated with an impacted microservice 210 may be updated with one or more updates to the changed localized files during an execution of the impacted microservice 210. A translation of a given text portion of a message associated with a given microservice 210 of a globalized application may be reused in some embodiments across the plurality of microservices 210.

FIG. 3 illustrates an installation stage 300 of a plurality of microservices 310-1 through 310-N (collectively, referred to herein as microservices 310) of a globalized application in accordance with an illustrative embodiment. In the example of FIG. 3, a plurality of localization packages 305-1 through 305-N (collectively, referred to herein as localization packages 305) comprise, for example, the translations from the one or more translation services 260, which may be obtained from a shared storage 350. Localization packages 305 are sometimes referred to as language packs.

The localization packages 305-1 through 305-N may be provided to (e.g., installed in) respective microservices 310-1 through 310-N. In this manner, each microservice 310 is responsible for its respective data and localization package 305 (providing separation of concerns with respect to globalization). During the installation stage 300 of the microservices 310 of the globalized application, the localization packages 305-1 through 305-N (e.g., comprising the translations from the one or more translation services 260) associated with a given microservice 310 are provided to the given microservice 310 for storage in a respective data store 320 (of a plurality of data stores 320-1 through 320-N) associated with the given microservice 310. The localization packages 305 may be provided to the respective microservices 310, for example, by a centralized upgrade authority, or may be pulled by the respective microservices 310 from the shared storage 350. The given microservice 310 may store the respective localization package 305 in the respective data store 320 using one or more respective copy and/or write operations 315. The data stores 320-1 through 320-N may be part of the storage system 130 of FIG. 1A associated with each microservice 310.

FIG. 4 illustrates an execution stage 400 of a plurality of microservices 410-1 through 410-N (collectively, referred to herein as microservices 410) of a globalized application in accordance with an illustrative embodiment. In the example of FIG. 4, each microservice 410 has respective data elements 430 (of a plurality of data elements 430-1 through 430-N) and respective localization packages 435 (of a plurality of localization packages 435-1 through 435-N). In addition, each microservice 410 has a respective API 420-1 through 420-N for interacting with one or more client devices 405.

In some embodiments, the localization packages 435 are used to generate user messages with text portions that are translated into the localized target language, for example, using the identifier of each text portion in a given message to access the translation of the respective text portion into the localized target language, along with the localized formatting. For example, the globalization module 125 associated with a given microservice 410 may use a text portion identifier from a given source message, together with the known locale of a given user, to access the existing translation of the text portion (e.g., into a selected or designated target language associated with the known locale of the given user) from the respective localization package 435 of the given microservice 410. The globalization module 125 associated with each microservice 410 (or the corresponding internationalization source code of each microservice 410) performs the runtime translation of each incoming request into a local language, using the respective localization package 435, by identifying a particular translated version of a given source message that should be selected for presentation to a given user, for example, based on one or more client input parameters.

In this manner, a given microservice 410 can use an identifier associated with a given text portion of a message to obtain a translation of the given text portion into a localized language associated with a particular client device 405, optionally with the appropriate localized formatting as well. The given microservice 410 can present a particular message with a translation of text portions within the message to the particular client device 405 using the API 420 of the given microservice 410.

In various embodiments, the microservices 410-1 through 410-N can execute in a public cloud, a private cloud, and/or at a location of an organization, or variations thereof.

Among other benefits, the microservices 410 of FIG. 4 individually handle runtime language translations and formatting, thereby allowing each service to scale independently of other microservices without passthrough bottlenecks associated with conventional techniques.

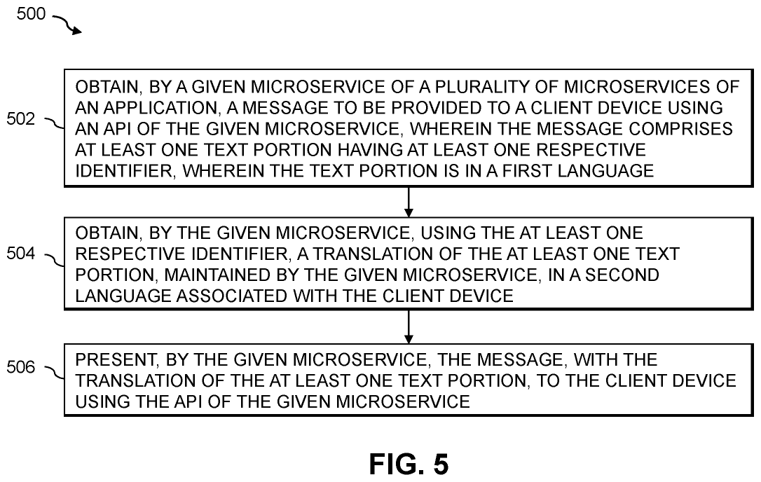

FIG. 5 is a flow chart illustrating an exemplary implementation of a process 500 for automated localization of microservices in accordance with an illustrative embodiment. In the example of FIG. 5, the process 500 obtains, in step 502, by a given microservice of a plurality of microservices of an application, a message to be provided to a client device using an API of the given microservice, wherein the message comprises at least one text portion having at least one respective identifier, wherein the at least one text portion is in a first language.

In step 504, the given microservice obtains, using the at least one respective identifier, a translation of the at least one text portion, maintained by the given microservice, in a second language associated with the client device. The given microservice presents the message, with the translation of the at least one text portion, to the client device in step 506 using the API of the given microservice.

In some embodiments, the application is written in the first language (e.g., a source language) using a designated programming language, and wherein the application is developed using continuous integration aggregation to (i) detect changes to one or more localized files of the application; (ii) transform the one or more changed localized files from the designated programming language of the application to a file format (e.g., a JSON format); and (iii) store the one or more changed localized files in the file format in a shared storage for translation by one or more translation organizations (e.g., into a plurality of localized target languages). The one or more translated localized files may be stored in the shared storage as language packages (sometimes referred to as language packs). During an installation of the application, the language packages associated with the given microservice can be provided to the given microservice for storage in a data store associated with the given microservice. The application may be updated with one or more updates to the one or more changed localized files during an execution of the application.

In one or more embodiments, the translation of the at least one text portion employs a formatting designated for the client device (e.g., a localized target or destination language). The application may execute in one or more of a public cloud, a private cloud, and at a location of an organization. A translation of a given text portion of the application may be reused in some embodiments, across the plurality of microservices.

The particular processing operations and other network functionality described in conjunction with FIG. 5, for example, are presented by way of illustrative example only, and should not be construed as limiting the scope of the disclosure in any way. Alternative embodiments can use other types of processing operations for automated localization of microservices. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

The term DevOps generally refers to a set of practices that combines software development and information technology (IT) operations. DevOps are increasingly being used to shorten the software development lifecycle and to provide continuous integration, continuous delivery, and continuous deployment. Continuous integration generally allows development teams to merge and verify changes more often by automating software builds (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment allows code changes that pass an automated testing phase to be automatically released into the production environment, thus making the changes visible to end users. Such processes are typically executed within the build and deployment pipeline.

The disclosed techniques for automated localization of microservices can be employed, for example, to improve a development phase for a globalized application by handling Globalization within each respective microservice and employing CI/CD tools to aggregate the globalization data from distributed microservices to provide the necessary text portions in a source language to one or more translation systems for translation into localized target languages. Each microservice retrieves and stores its respective localization data, and performs runtime translation using its respective localization data. Thus, developers of a given microservice manage a single repository for the microservice code and the microservice-specific localization data. During an execution of the given microservice, the given microservice performs its own translations, using a lookup into the respective localization data to thereby remove the overhead of additional internationalization service device behavior calls.

One or more embodiments of the disclosure provide improved methods, apparatus and computer program products for automated localization of microservices. The foregoing applications and associated embodiments should be considered as illustrative only, and numerous other embodiments can be configured using the techniques disclosed herein, in a wide variety of different applications.

It should also be understood that the disclosed automated microservice localization techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated localization of microservices may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based automated microservice localization engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based automated microservice localization platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

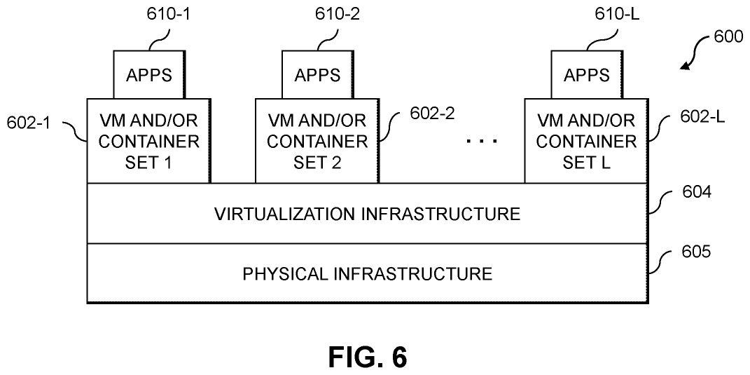

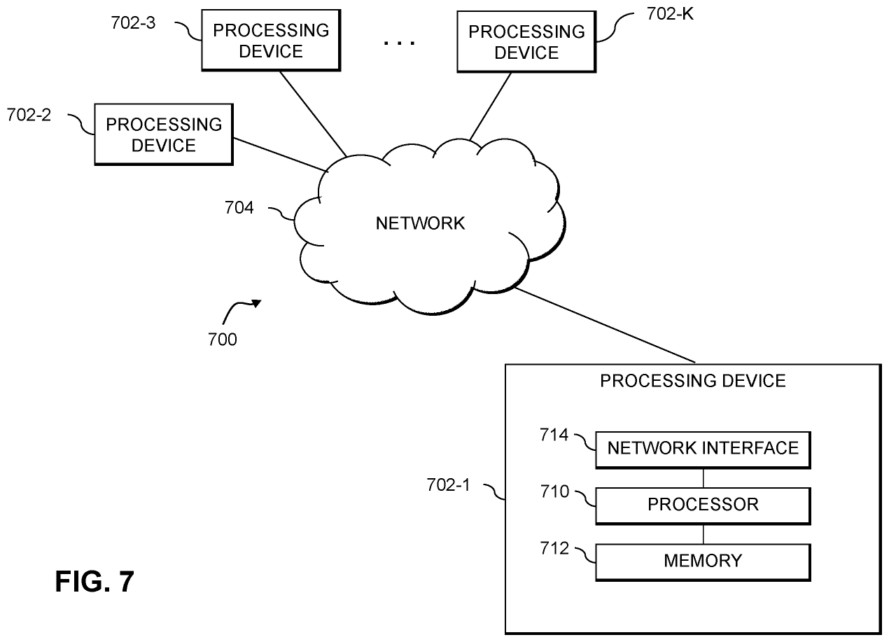

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide automated microservice localization functionality of the type described above for one or more processes running on a given one of the VMs. For example, each of the VMs can implement automated microservice localization control logic and associated message translation functionality for one or more processes running on that particular VM.

An example of a hypervisor platform that may be used to implement a hypervisor within the virtualization infrastructure 604 is the VMware® vSphere® which may have an associated virtual infrastructure management system such as the VMware® vCenter™. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide automated microservice localization functionality of the type described above for one or more processes running on different ones of the containers. For example, a container host device supporting multiple containers of one or more container sets can implement one or more instances of automated microservice localization control logic and associated message translation functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, an FPGA or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining, by a given microservice of a plurality of microservices of an application, a message to be provided to a client device using an application programming interface of the given microservice, wherein the message comprises at least one text portion having at least one respective identifier, wherein the at least one text portion is in a first language;
obtaining, by the given microservice, using the at least one respective identifier, a translation of the at least one text portion, maintained by the given microservice, in a second language associated with the client device; and
presenting, by the given microservice, the message, with the translation of the at least one text portion, to the client device using the application programming interface of the given microservice;
wherein the method is performed by at least one processing device comprising a processor coupled to a memory.

2. The method of claim 1, wherein the application is written in the first language using a designated programming language, and wherein the application is developed using continuous integration aggregation to (i) detect changes to one or more localized files of the application; (ii) transform the one or more changed localized files from the designated programming language of the application to a file format; and (iii) store the one or more changed localized files in the file format in a shared storage for translation by one or more translation organizations.

3. The method of claim 2, wherein the one or more translated localized files are stored in the shared storage as language packages.

4. The method of claim 3, wherein, during an installation of the application, the language packages associated with the given microservice are provided to the given microservice for storage in a data store associated with the given microservice.

5. The method of claim 2, wherein the application is updated with one or more updates to the one or more changed localized files during an execution of the application.

6. The method of claim 1, wherein the translation of the at least one text portion employs a formatting designated for the client device.

7. The method of claim 1, wherein the application executes in one or more of a public cloud, a private cloud, and at a location of an organization.

8. The method of claim 1, wherein a translation of a given text portion of the application is reused across the plurality of microservices.

9. An apparatus comprising:
at least one processing given device comprising a processor coupled to a memory;
the at least one processing given device being configured to implement the following steps:
obtaining, by a given microservice of a plurality of microservices of an application, a message to be provided to a client device using an application programming interface of the given microservice, wherein the message comprises at least one text portion having at least one respective identifier, wherein the at least one text portion is in a first language;
obtaining, by the given microservice, using the at least one respective identifier, a translation of the at least one text portion, maintained by the given microservice, in a second language associated with the client device; and
presenting, by the given microservice, the message, with the translation of the at least one text portion, to the client device using the application programming interface of the given microservice.

10. The apparatus of claim 9, wherein the application is written in the first language using a designated programming language, and wherein the application is developed using continuous integration aggregation to (i) detect changes to one or more localized files of the application; (ii) transform the one or more changed localized files from the designated programming language of the application to a file format; and (iii) store the one or more changed localized files in the file format in a shared storage for translation by one or more translation organizations.

11. The apparatus of claim 10, wherein the one or more translated localized files are stored in the shared storage as language packages.

12. The apparatus of claim 11, wherein, during an installation of the application, the language packages associated with the given microservice are provided to the given microservice for storage in a data store associated with the given microservice.

13. The apparatus of claim 10, wherein the application is updated with one or more updates to the one or more changed localized files during an execution of the application.

14. The apparatus of claim 9, wherein a translation of a given text portion of the application is reused across the plurality of microservices.

15. A non-transitory processor-readable storage medium having stored therein program code of one or more software programs, wherein the program code when executed by at least one processing given device causes the at least one processing given device to perform the following steps:
obtaining, by a given microservice of a plurality of microservices of an application, a message to be provided to a client device using an application programming interface of the given microservice, wherein the message comprises at least one text portion having at least one respective identifier, wherein the at least one text portion is in a first language;
obtaining, by the given microservice, using the at least one respective identifier, a translation of the at least one text portion, maintained by the given microservice, in a second language associated with the client device; and
presenting, by the given microservice, the message, with the translation of the at least one text portion, to the client device using the application programming interface of the given microservice.

16. The non-transitory processor-readable storage medium of claim 15, wherein the application is written in the first language using a designated programming language, and wherein the application is developed using continuous integration aggregation to (i) detect changes to one or more localized files of the application; (ii) transform the one or more changed localized files from the designated programming language of the application to a file format; and (iii) store the one or more changed localized files in the file format in a shared storage for translation by one or more translation organizations.

17. The non-transitory processor-readable storage medium of claim 16, wherein the one or more translated localized files are stored in the shared storage as language packages.

18. The non-transitory processor-readable storage medium of claim 17, wherein, during an installation of the application, the language packages associated with the given microservice are provided to the given microservice for storage in a data store associated with the given microservice.

19. The non-transitory processor-readable storage medium of claim 16, wherein the application is updated with one or more updates to the one or more changed localized files during an execution of the application.

20. The non-transitory processor-readable storage medium of claim 15, wherein a translation of a given text portion of the application is reused across the plurality of microservices.
